(19) United States
(12) Patent Application Publication
(10) Pub. No.: US 2009/0119460 A1
(43) Pub. Date: May 7, 2009

(54) Storing Portions of a Data Transfer Descriptor in Cached and Uncached Address Space

(75) Inventors: Jinan Lin, Ottobrunn (DE); Xiaoning Nie, Neubiberg (DE); Stefan Maier, Augsburg (DE)

Correspondence Address: BANNER & WITCOFF, LTD.;Attorneys for client 007052, 1100 13th STREET, N.W., SUITE 1200, WASHINGTON, DC, 20005-4051, US

(73) Assignee: INFINEON TECHNOLOGIES AG, Neubiberg (DE)

(21) Appl. No.: 11/936,309

(22) Filed: Nov. 7, 2007

(51) Int. Cl. G06F 12/00

(52) U.S. Cl. 711/138; 711/E12.001

(57) ABSTRACT

Methods, apparatuses, and software for storing a first portion of a data transfer descriptor in cached address space, and storing a second portion of the data transfer descriptor in uncached address space. Also, methods, apparatuses, and software for reading at least a portion of a data transfer descriptor from cached address space, initiating a memory transfer based on the data transfer descriptor, and storing a parameter indicating a status of the data transfer descriptor in uncached address space.

### BACKGROUND

Digital processing systems typically include a central processing unit (CPU) and a main memory. The speed at which the CPU can decode and execute instructions and operands depends upon the rate at which the instructions and operands can be transferred from main memory to the CPU and/or between other devices in the system. Accordingly, many systems now use direct memory access (DMA), which refers to a technique for transferring data between a peripheral device and main memory between two devices, or between buffers within main memory, without the need for the CPU to be involved in the transfer.

Using DMA, the CPU can initiate the copy operation and then move on to other operations while the copying is occurring, without the need for CPU intervention during the copying operation. Depending on the type of DMA service, either the device sending/receiving the data or a separate DMA controller performs the copying. Conceptually, it is simple for the CPU to control all DMA transfers through a DMA controller. For each transfer, the CPU informs the controller of the transfer parameters (the source and destination addresses/pointers, the size of the data to be transferred, etc.) using a DMA descriptor, which is effectively a form of detailed transfer instruction. The DMA controller can perform the transfer based on the DMA descriptor without further intervention by the CPU. After the transfer has completed, the DMA controller informs the CPU of the completion.

To further increase system speed, many systems also include a cache memory between the CPU and the main memory. The cache memory is a small and very high-speed memory intended to store a copy of selected portions of data in the main memory; thus the cache memory is supposed to be a duplicate of portions of the main memory. By using cache memory, the CPU does not need to refer to the relatively slow main memory as frequently, thereby potentially speeding up processing.

However, the use of cache memory raises potential coherency issues. Data written by the CPU may be initially stored in the cache memory but not the main memory (until the main memory is eventually updated). Conversely, data written by the DMA controller may be initially stored in the main memory but not the cache memory (until the cache memory is eventually updated). This means that the CPU and the DMA controller may observe different data values stored in the same memory locations shared between the cache and main memories. Such incoherency may prevent DMA from operating correctly in certain situations.

### SUMMARY

Some illustrative aspects as described herein are directed to various methods, apparatuses, and software for storing a first portion of a data transfer descriptor in cached address space, and storing a second portion of the data transfer descriptor descriptor in uncached address space.

Further illustrative aspects as described herein are directed to reading at least a portion of a data transfer descriptor from cached address space, initiating a memory transfer based on the DMA descriptor, and storing a parameter indicating a status of the data transfer descriptor in uncached address space.

These and other aspects of the disclosure will be apparent upon consideration of the following detailed description of illustrative aspects.

### BRIEF DESCRIPTION OF THE DRAWINGS

A more complete understanding of the present disclosure may be acquired by referring to the following description in consideration of the accompanying drawings, in which like reference numbers indicate like features, and wherein:

FIG. 1 is a functional block diagram of an illustrative embodiment of a system including a central processing unit (CPU), a direct memory access controller (DMAC), and memory;

FIG. 2 is a functional block diagram of an illustrative embodiment of a DMAC;

FIG. 3 is an illustrative embodiment of an arrangement of a direct memory access (DMA) descriptor; and

FIG. 4 is a functional block diagram of an illustrative embodiment of an architecture between a CPU and a DMAC.

### DETAILED DESCRIPTION

The various aspects described herein may be embodied in various forms. The following description shows by way of illustration various examples in which the aspects may be practiced. It is understood that other examples may be utilized, and that structural and functional modifications may be made, without departing from the scope of the present disclosure.

Except where explicitly stated otherwise, all references herein to two or more elements being “coupled,” “connected,” and “interconnected” to each other is intended to broadly include both (a) the elements being directly connected to each other, or otherwise in direct communication with each other, without any intervening elements, as well as (b) the elements being indirectly connected to each other, or otherwise in indirect communication with each other, with one or more intervening elements.

As will be described herein in further detail, various illustrative embodiments will be discussed in which unpredictable information is separated from a direct memory access (DMA) descriptor (or other type of data transfer descriptor) so that the descriptor becomes cacheable with software coherency assurance, thereby potentially making full use of the cache while preserving coherency. To this end, it may be assumed that data cache manipulation is supported by the central processing unit (CPU) instruction set architecture, but without necessarily requiring hardware cache coherency support. For example, the MIPS 24KeC core, marketed by MIPS Technologies, supports such cache operations but no cache coherency. The unpredictable information separated from the predictable information may be stored in uncached address space. However, because the unpredictable information can be kept very small (in some cases only a single bit), access overhead experienced due to reading from the relatively slow uncached address space may be negligible.

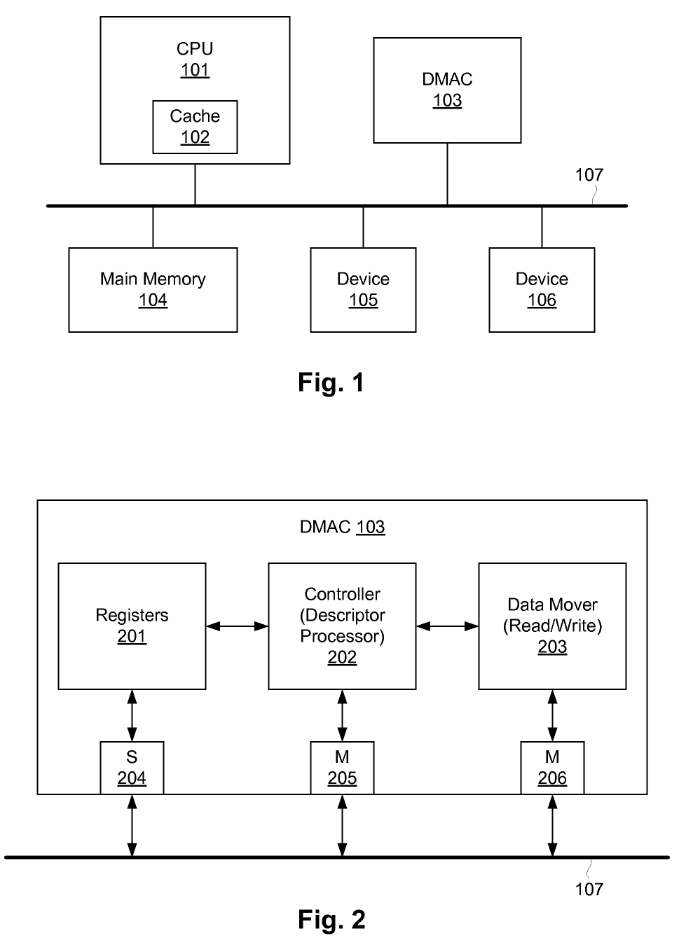

FIG. 1 shows an illustrative embodiment of a system that may utilize DMA. The system as shown includes a CPU 101 or other processor, a cache memory 102, a DMA controller (DMAC) 103, a main memory 104, and one or more other devices 105, 106. Some or all of these elements may be interconnected via a bus 107. Thus, data may flow between these various elements over bus 107.

The system may include a storage resource that includes both cached address space and uncached address space. In the present example, the cached address space is depicted as cache memory 102, and the uncached address space is depicted as at least a portion of main memory 104. However, the cached and uncached address spaces may be embodied in any form, may be separate memories, may share the same physical memory (but with different address space within the same memory), and may be located anywhere in the system. Moreover, each of the cached and uncached address spaces may be made up of a single contiguous span of address space or a plurality of non-contiguous spans of address space, as desired.

For example, cache memory 102 and main memory 104 each may be physically located at and/or co-packaged with CPU 101. For example, cache memory 102 and/or main memory 104 may be physically on the same integrated circuit chip as CPU 101. Cache memory 102 and/or main memory 104 may alternatively or additionally be located physically separately from CPU 101. Moreover, cache memory 102 and/or main memory each may be one or more physical memories, such as one or more memory chips. And, cache memory 102 and main memory 104 may be physically different memories (e.g., different memory chips) and/or reside on one or more of the same memory chips. In any of these configurations, cache memory 102 may appear logically as cached address space and main memory 104 may appear logically as uncached address space, regardless of the actual physical realization of these memories. In other embodiments, at least a portion of the uncached address space may be provided as one or more registers, such as registers within DMAC 103.

Devices 105 and 106 may be any type of other devices that may communicate directly or indirectly with CPU 101, such as one or more storage devices, output devices (e.g., monitors, printers), one or more input devices (e.g., keyboards, mice), one or more communication interfaces (e.g., modems, wireless network cards), one or more circuit boards, one or more network cards, and/or any other type of on-chip or off-chip device. In addition, devices 105 and 106 may be embodied as, for example, universal serial bus (USB) devices, peripheral component interconnect (PCI) devices, universal asynchronous receiver/transmitter (UART) devices, Ethernet devices, or radio frequency (RF) devices.

DMAC 103 may be embodied as a separate integrated circuit chip, however DMAC 103 may be embodied as any type of circuitry desired, and may be partially or fully integrated with CPU 101, or physically separate from CPU 101.

FIG. 2 shows an illustrative embodiment of DMAC 103. As shown, DMAC 103 includes one or more registers 201 (for storing data), a controller 202, and a data mover 203. In addition, registers 201 may communicate with bus 107 via a slave interface 204 so that CPU 101 may write to and read from the registers therein. Controller 202 may communicate with bus 107 via a master interface 205 so that it can exchange information with CPU 101, in particular DMA descriptors. Data mover 203 may communicate with bus 107 via a master interface 206. Alternatively, DMAC 103 may have only a single master interface to bus 107. In operation, data mover reads data of a given size from a given source storage location and writes it to a given destination storage location, both via master interface 206. Controller 202 controls the data movement, and works in accordance with registers 201 that are written to by CPU 101 to configure, initialize, and/or control DMAC 103. The working status of DMAC 103 is also stored and updated in one or more of the registers in unit 201.

DMACs are typically organized into a plurality of logical channels. In this case DMAC 103 may also be organized into a plurality of logical channels, so that CPU 101 may use these channels to transfer multiple data streams in parallel. In some embodiments, DMAC 103 has for each channel a register set to maintain the working context.

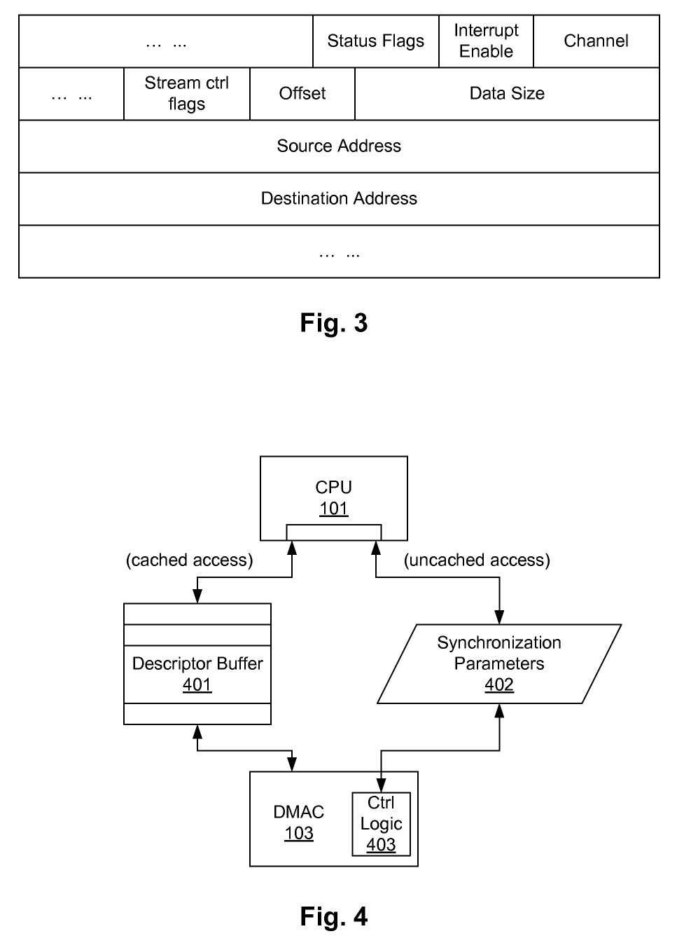

As previously mentioned, CPU 101 provides DMA descriptors to DMAC 103. FIG. 3 shows an illustrative embodiment of the layout of a DMA descriptor. As shown, a DMA descriptor may include data representing one or more status flags, which may indicate the processing status of the DMA descriptor. For example, one or more of the status flags may indicate whether the data to be transferred has yet to be transferred, or is in the process of being transferred, or has completed being transferred. The DMA descriptor as shown may further include an interrupt enable, one or more application-specific parameters such as stream control flags, an offset, an indication of the size of data to be transferred, an indication of the source address that the data to be transferred is to be found, and an indication of the destination address to which the data to be transferred is to be written. The DMA descriptor may also include other data.

In general, the DMA descriptor may provide sufficient information to DMAC 103 to identify which data is to be transferred and where it is to be transferred to. In operation, CPU 101 may generate the DMA descriptor and hand the DMA descriptor over to DMAC 103. Then, DMAC 103 may perform the transfer described by the DMA descriptor and may modify the descriptor (e.g., the status flags) to indicate the data transfer status. Then modified descriptor may then be used by CPU 101 for any post-processing activities as desired.

DMA descriptors on each channel are often organized in groups, such as chains where multiple data transfer requests are linked together. Each group may further have one or more sub-groups, such as a chain for each channel. Data may be scattered among and/or gathered from different locations during the transfers. The descriptor chain may be buffered in the main memory in a pre-defined ring buffer, for example, or in a dynamically allocated link list. In the latter case, the linking information may be contained in the descriptors themselves.

Other variations of multiple DMA descriptor organization may be employed. For example, a DMA descriptor may point to one or more sub-descriptor chains. Each sub-chain, in turn, may describe a series of data transfers, where the data may have some logical relation to each other. Such an organization may be found in conventional network protocol processing, where packet headers are stored separately from the packet payloads. The payload, in turn, may encapsulate packets of a higher layer, which are also stored separately.

As will be described next, the processing of descriptors may be considered in three phases. For example, first the CPU may generate or otherwise prepare descriptors and hand them over to the DMA controller. This may be done, for instance, by changing the owner of the descriptors from the CPU to the DMA controller. Next, for example, the DMA controller may carry out the data transfers on the descriptors and set one or more data streaming parameters in the descriptors as appropriate. The DMA controller may further update one or more synchronization parameters of the descriptors according to the status of the data transfers. Then, the DMA controller may hand the descriptors back to the CPU. Finally, when scheduled, the CPU may for example check the synchronization parameter(s) to decide what to do next. If the synchronization parameter(s) indicate that the transfer is completed, the descriptor may be removed (such that the buffer is freed) or invalidated (such that the buffer is retained). The descriptors may additionally or alternatively be refreshed for new transfers and handed back over to the DMA controller.

It can be seen that, although the CPU and the DMA controller share the descriptors, they in principle do not experience cross access by each other during their own phases. In other words, a given descriptor is worked on by either the CPU or the DMA controller at any given time. However, it is unpredictable as to when a descriptor will actually be completed and given back to the CPU by the DMA controller. One possible solution to this would be to store the entire DMA descriptor in uncached address space, thus preventing coherency issues caused this unpredictable property of DMA descriptor processing. However, it would likely be quite inefficient to store the entire DMA descriptor in uncached address space. On the other hand, by separating out the unpredictable property (i.e., the portion representing the working status of the DMA descriptor) of a descriptor and mapping this portion to uncached address space, the remaining portion of the DMA descriptor could be stored in cached address space rather than uncached (and thus typically slower) address space. If the unpredictable portion is kept small, then great efficiency may be realized because a relatively tiny (and perhaps even negligible) portion of the DMA descriptor would be stored in uncached memory.

In such a case where the predictable portions of DMA descriptors are stored in cached address space, the CPU could merely flush and invalidate the cache lines containing the DMA-ready descriptors to let them be seen by the DMA controller. So long as the CPU is notified that a descriptor is handed back to the CPU and tries to access the descriptor, the descriptor will be reloaded back into the cache, automatically via a cache miss.

FIG. 4 shows an illustrative embodiment of an architecture that may be used to separate predictable and unpredictable portions of DMA descriptors or other types of descriptors into cached and uncached address spaces, respectively. In this embodiment, descriptors are shared by CPU 101 and DMAC 103. The predictable portions of descriptors may be stored in cached address space, such as cache 102 and/or a descriptor buffer 401, while unpredictable portions of descriptors may be stored in uncached address space, such as main memory 104 or registers 201. The unpredictable portion may include one or more synchronization parameters 402, which are updated by DMAC 103 to reflect the current transaction status of the descriptor. These synchronization parameters 402 may be read/polled by CPU 101 to determine the status of a descriptor or group of descriptors, such as whether a descriptor or portion of a descriptor group is completed by DMAC 103. Because there is no way of reliably knowing when a particular descriptor is to be completed, synchronization parameters 402 should be kept coherent to CPU 101. This is why synchronization parameters 402 are stored in uncached address space.

A synchronization parameter 402 may be provided for each descriptor, if desired. However, taking note of the fact that the descriptors of a DMA channel are typically dealt with in their natural order in the chain sequentially, it is sufficient that only one synchronization parameter 402 be provided per DMA channel, rather than per descriptor. The use of synchronization parameter 402 to represent a plurality of DMA descriptors (rather than only a single DMA descriptor) may be applied generally to any group of DMA descriptors that are processed by DMAC 103 in a predetermined known order. Thus, in some embodiments, synchronization parameter 402 may be provided for any group of DMA descriptors having a known processing order. Several illustrative embodiments of such synchronization parameters 402 will now be described.

In one illustrative embodiment, the synchronization parameter 402 may be a single bit per DMAC channel. This bit may indicate whether or not there is any descriptor in the channel that has been completed by DMAC 103 (i.e., whether or not the data transfer described by any descriptor in the channel has been completed). Because CPU 101 is able to read this bit set, CPU 101 may start to load and process descriptors in that channel, one after the other, starting with the oldest descriptor. CPU 101 would then stop processing descriptors in the channel when it reaches a descriptor having a status of uncompleted. At that point, CPU 101 may clear synchronization parameter 402 for that channel and turn to other tasks. In addition, CPU 101 would invalidate the last loaded descriptor in the cache, since the last loaded descriptor has not yet been completed by DMAC 103. Thus, this particular embodiment may involve an additional cache miss due to previously loading the last descriptor (i.e., the uncompleted descriptor). Moreover, mutual-exclusion logic may be needed for implementing the single-bit embodiment because it can be updated by both CPU 101 and by DMAC 103.

In another illustrative embodiment, the single bit synchronization parameter 402 embodiment may be replaced with data representing a count for each channel of the number of descriptors newly completed by DMAC 103 in that channel. Each time CPU 101 reads the count, CPU 101 may process the number of descriptors in a channel indicated by the count for that channel. The counter would then be reset or otherwise stepped down appropriately as the descriptors are read or otherwise processed. In this particular embodiment, CPU 101 would not necessarily need to read and invalidate one additional descriptor, thus potentially being more efficient time-wise than the single-bit embodiment.

In still another illustrative embodiment, synchronization parameter 402 may be data representing a storage location (e.g., an address or index) of the last completed descriptor. Thus, in this embodiment, CPU 101 may read synchronization parameter 402 for a given channel and then process descriptors in that channel until it reaches the descriptor whose address/index is equal to the parameter.

The various illustrative embodiments described herein may not necessarily require major hardware changes to conventional systems. For example, DMAC 103 may be modified to include or have access to a control circuit 403 that allows DMAC 103 to read, generate, and modify synchronization parameter 402. In addition, synchronization parameter 402 may be stored in any uncached address space, including for example one or more registers that may be part of DMAC 103 (e.g., registers 201 or additional registers added to DMAC 103). Any software changes to implement the above-described embodiments may involve, for instance, adding an instruction to flush and/or invalidate the cache line before delivering it to DMAC 103.

Any performance impact of having to access synchronization parameter 402 in uncached memory would be directly related to how often such uncached access occurs. Depending upon the particular implementation, it may be that a large number of descriptors on average are processed for each reading/polling of synchronization parameter 402. Thus, the uncached access overhead may be kept very small, thereby detrimenting performance by a very small, if negligible, amount.

It should be noted that the various concepts described herein may be applied to any multi-processor system, and not just limited to a system having a CPU and a DMAC. For instance, the CPU may be replaced with any type of first processor and the DMAC may be replaced with any type of second processor. In addition, while various embodiments have been described with respect to processing DMA descriptors, the concepts discussed herein may work equally well with other types of data transfer descriptors.

1. A method, comprising:
storing a first portion of a data transfer descriptor in cached address space; and
storing a second portion of the data transfer descriptor in uncached address space.

2. The method of claim 1, further comprising:
reading the first portion of the data transfer descriptor from the cached address space;
initiating a data transfer based on the first portion of the data transfer descriptor as read from the cached address space; and
revising the second portion of the data transfer descriptor in the uncached address space in accordance with a status of the data transfer.

3. The method of claim 2, further comprising:
responsive to the revised second portion of the data transfer descriptor indicating that the data transfer is complete, performing one of removing the first portion of the DMA descriptor from the cached address space and invalidating the first portion of the DMA descriptor in the cached address space.

4. A method, comprising:
reading at least a portion of a data transfer descriptor from cached address space;
initiating a data transfer based on the data transfer descriptor; and
storing a parameter indicating a status of the data transfer descriptor in uncached address space.

5. The method of claim 4, further comprising:
reading the parameter from the uncached address space; and
performing a function based on the status indicated by the parameter.

6. The method of claim 4, further comprising:
reading the parameter from the uncached address space; and
responsive to the parameter indicating a particular status, reading the data transfer descriptor from the cached address space.

7. The method of claim 4, further comprising:
generating the data transfer descriptor by a CPU; and
changing an owner of the data transfer descriptor to a data transfer controller,
wherein reading the at least the portion of the data transfer descriptor, initiating the data transfer, and storing the parameter are performed by the data transfer controller.

8. The method of claim 4, further comprising:
responsive to the parameter indicating that the data transfer is complete, performing one of removing the at least the portion of the data transfer descriptor from the cached address space and invalidating the at least the portion of the data transfer descriptor in the cached address space.

9. An apparatus, comprising:
a storage resource comprising cached address space and uncached address space;
a first processor configured to generate a first plurality of data transfer descriptors, and store the first plurality of data transfer descriptors in the cached address space; and
a second processor coupled to the first processor and configured to store a first parameter indicating a status of the first plurality of data transfer descriptors in the uncached address space.

10. The apparatus of claim 9, wherein:
the second processor is further configured to initiate a first plurality of data transfers each in accordance with one of the first plurality of stored data transfer descriptors, and to revise the first parameter as stored in the uncached address space in accordance with a status of the first plurality of memory transfers, and
the first processor is further configured to perform a first function depending upon the revised first parameter.

11. The apparatus of claim 9, wherein the first processor comprises a central processing unit (CPU) and the second processor comprises a direct memory access controller (DMAC).

12. The apparatus of claim 9, wherein the first plurality of data transfer descriptors are each at least a portion of a direct memory access (DMA) descriptor.

13. The apparatus of claim 9, wherein the first parameter consists of a single bit.

14. The apparatus of claim 9, wherein the first parameter comprises data indicating a count of a number of the first plurality of data transfer descriptors associated with a completed data transfer.

15. The apparatus of claim 9, wherein the first parameter comprises data indicating a location in the cached address space of a last completed one of the first plurality of data transfer descriptors.

16. The apparatus of claim 9, further comprising performing at least one of removing one of the first plurality of data transfer descriptors from the cached address space and invalidating the one of the first plurality of data transfer descriptors in the cached address space.

17. The apparatus of claim 9, wherein:
the second processor is further configured to receive the stored first plurality of data transfer descriptors over a first channel of the second processor;
the first processor is further configured to generate a second plurality of linked data transfer descriptors;
the second processor is further configured to store the second plurality of data transfer descriptors in the cached address space, store a second parameter indicating a status of the second plurality of data transfer descriptors in the uncached address space;
receive the stored second plurality of data transfer descriptors over a second channel of the second processor, initiate a second plurality of data transfers each in accordance with one of the second plurality of stored data transfer descriptors, and revise the second parameter as stored in the uncached address space in accordance with a status of the second plurality of data transfers; and
the second processor is further configured to perform a second function depending upon the revised second parameter.

18. The apparatus of claim 17, wherein the first parameter consists of a first single bit and the second parameter consists of a second single bit.

19. The apparatus of claim 17, wherein the first parameter comprises data indicating a count of a number of the first plurality of data transfer descriptors associated with a completed data transfer, and the second parameter comprises data indicating a count of a number of the second plurality of data transfer descriptors associated with a completed data transfer.

20. The apparatus of claim 17, wherein the first parameter comprises data indicating a location in the cached address space of a last completed one of the first plurality of data transfer descriptors, and the second parameter comprises data indicating a location in the cached address space of a last completed one of the second plurality of data transfer descriptors.

21. An apparatus, comprising:
a storage resource comprising cached address space and uncached address space;
a first processor configured to generate a plurality of data transfers descriptors and store at least a portion of each of the plurality of data transfer descriptors in the cached address space; and
a second processor coupled to the first processor and configured to initiate data transfers based on the stored plurality of data transfer descriptors and to set a parameter in the uncached address space, the parameter indicating a status of the plurality of data transfer descriptors.

22. The apparatus of claim 21, wherein the first processor comprises a central processing unit (CPU), the second processor comprises a DMA controller (DMAC), and each of the data transfer descriptors comprises a direct memory access (DMA) descriptor.

23. The apparatus of claim 22, wherein the uncached address space comprises a register that is part of the DMAC.

24. The apparatus of claim 21, wherein the first processor is further configured to read the parameter stored in the uncached address space and to perform a function depending upon the stored parameter.

25. An apparatus, comprising:
a storage resource comprising cached address space and uncached address space;
a first processor configured to generate a plurality of data transfer descriptors and store at least a portion of each of the plurality of data transfer descriptors in the cached address space; and
a second processor coupled to the first processor and configured to initiate data transfers based on the stored plurality of data transfer descriptors and to set a plurality of parameters in the uncached address space, each of the parameters indicating a status of one of the plurality of data transfer descriptors.
